(19) United States
(12) Patent Application Publication
(10) Pub. No.: US 2005/0052799 A1
(43) Pub. Date: Mar. 10, 2005

(54) ESD protecting circuit embedded in an SIP chip using a plurality of power sources

(75) Inventors: Byeong-yun Kim, Seoul (KR); Jung-su Ryu, Gyeonggi-do (KR); Bong-jae Kwon, Gyeonggi-do (KR)

Correspondence Address: Steven M. Mills;MILLS & ONELLO LLP, Suite 605, Eleven Beacon Street, Boston, MA, 02108, US

(73) Assignee: Samsung Electronics Co., Ltd.

(21) Appl. No.: 10/933,765

(22) Filed: Sep. 3, 2004

(30) Foreign Application Priority Data
Sep. 4, 2003 (KR) 03-61701

(51) Int. Cl. H02H 9/04

(52) U.S. Cl. 361/56

(57) ABSTRACT

An ESD (electrostatic discharge) circuit embedded in an SIP (system-in-package) chip using a plurality of power sources is provided. The SIP chip includes: a first chip having a first electrostatic discharge protecting circuit between a first power voltage and a first ground voltage; a second chip having a second ESD protecting circuit between a second power voltage and a second ground voltage; a first coupling diode unit having a plurality of diodes which are serially connected between the first power voltage and the second power voltage in a bidirectional manner; and a second coupling diode unit having a plurality of diodes which are serially connected between the first ground voltage and the second ground voltage in a bidirectional manner, so that the ESD stress applied to each chip can sink to the power source in the corresponding chip and the other power sources in the other chip by connecting different power sources in the SIP chip through the coupling diode unit.

### BACKGROUND OF THE INVENTION

This application claims the priority of Korean Patent Application No. 2003-61701, filed on Sep. 4, 2003, in the Korean Intellectual Property Office, the contents of which ate incorporated herein in their entirety by reference.

1. Field of the Invention

The present invention relates to an ESD (electrostatic discharge) protecting circuit, and more particularly, to an ESD protecting circuit embedded in an SIP (system-in-package) using a plurality of power sources.

2. Description of the Related Art

Technologies for protecting an integrated circuit, particularly employing a single power voltage, from unwanted high voltages or currents such as ESD (electrostatic discharge) are well known in the art. In such an integrated circuit employing a single power voltage, an ESD protecting circuit is provided between a power voltage and a ground voltage to protect the integrated circuit from an ESD stress such as an HBM (human body mode) caused by a human being, an MM (machine mode) caused by equipment, and a CDM (charged device mode) caused by the integrated circuit. Systems employing a plurality of power sources also need an ESD protecting circuit between each power voltage and ground voltage.

SIP (system in package) technology has been introduced to address the demand for continuously reducing chip size and continuously increasing capacity of a semiconductor integrated circuit. SIP technology increases degree of integration by attaching two or more chips within one package.

FIG. 1 is a circuit diagram illustrating an ESD protecting circuit in a conventional SIP chip. A first chip 101 and a second chip 102 are installed in the SIP chip 100. In this description, the first chip 101 is mounted on the second chip 102. The first chip 101 uses a first power voltage VDD1 as a power source and a first ground voltage VSS1, and the second chip 102 uses a second power voltage VDD2 as a power source and a second ground voltage VSS2.

In the ESD protecting circuit 110 for the first chip 101, two diodes are respectively connected between a first pad PAD1 and the first power voltage VDD1 as well as between the first ground voltage VSS1 and the first pad PAD1. Similarly, in the ESD protecting circuit 120 for the second chip 102, two diodes are respectively connected between the second pad PAD2 and the second power voltage VDD2 as well as between the second ground voltage VSS2 and the second pad PAD2. That is, the first and the second chips 101 and 102 installed in the SIP chip 100 include the ESD protecting circuits between power voltages VDD1 and VDD2 and ground voltages VSS1 and VSS2, respectively, so that each chip 101 and 102 can prevent ESD stress from being applied to each of the chips 101 and 102.

### SUMMARY OF THE INVENTION

Accordingly, the present invention provides an ESD (electrostatic discharge) protecting circuit which commonly uses power voltages in an SIP (system-in-package) chip.

The present invention also provides an electrostatic protecting circuit for a system using a plurality of power sources.

According to an aspect of the present invention, a system-in-package chip comprises: a first chip having a first electrostatic discharge protecting circuit between a first power voltage and a first ground voltage; a second chip having a second electrostatic discharge protecting circuit between a second power voltage and a second ground voltage; a first coupling diode unit having a plurality of diodes which are serially connected between the first power voltage and the second power voltage in a bidirectional manner; and a second coupling diode unit having a plurality of diodes which are serially connected between the first ground voltage and the second ground voltage in a bidirectional manner.

The first electrostatic discharge protecting circuit may include: a first diode connected from a predetermined pad in the first chip to the first power voltage; and a second diode connected from the first ground voltage to the pad. Also, the second electrostatic discharge protecting circuit may include: a first diode connected from a predetermined pad in the second chip to the second power voltage; and a second diode connected from the second ground voltage to the pad.

According to another aspect of the present invention, an integrated circuit using a plurality of power sources comprises: a first power voltage; a second power voltage having a voltage level different than the first power voltage; a first ground voltage; an electrostatic discharge protecting circuit connected among the first power voltage, a predetermined pad in the integrated circuit, and the first ground voltage; and a first coupling diode unit having a plurality of diodes which are serially connected between the first power voltage and the second power voltage in a bidirectional manner.

The integrated circuit may further comprise: a second ground voltage having a voltage level different than the first ground voltage; and a second coupling diode unit having a plurality of diodes which are serially connected between the first ground voltage and the second ground voltage in a bidirectional manner.

Accordingly, the electrostatic discharge stress applied to each chip can sink to a power source in the corresponding chip and another power source in another chip by connecting different power sources in the SIP or IC chip through the coupling diode units.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a circuit diagram illustrating an ESD (electrostatic discharge) protection circuit in a conventional SIP (system-in-package) chip.

FIG. 2 is a circuit diagram illustrating an ESD protecting circuit in an SIP chip according to an embodiment of the present invention.

### DETAILED DESCRIPTION OF THE INVENTION

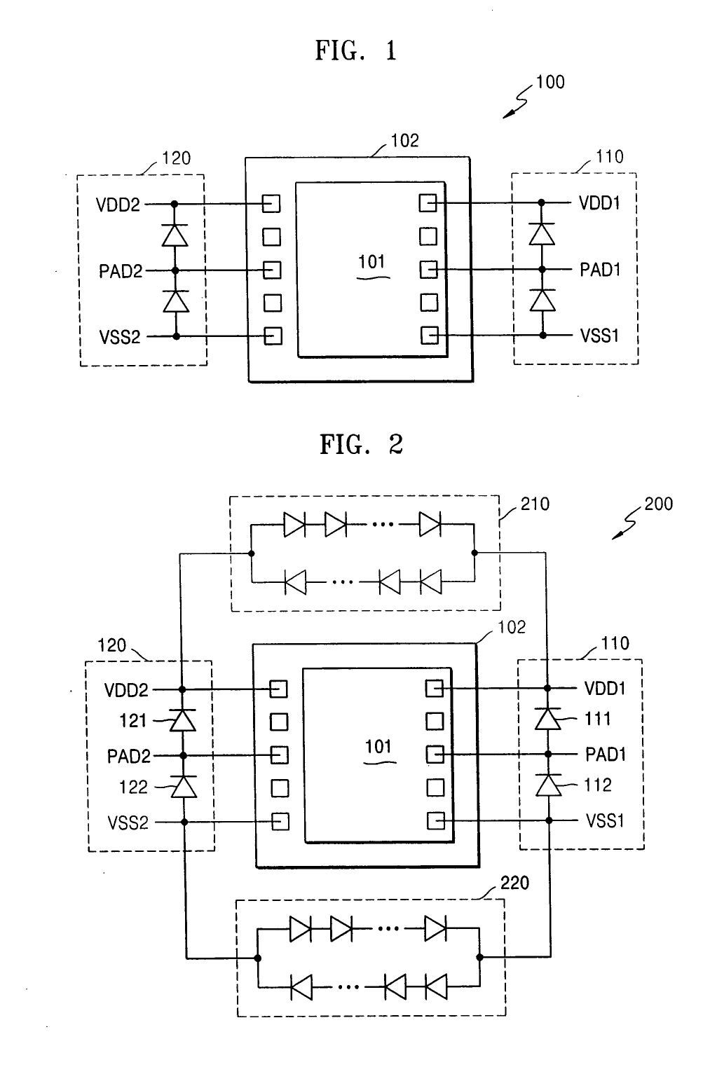

Referring again to FIG. 1, If the power voltages VDD1 and VDD2 and the ground voltages VSS1 and VSS2 in the SIP chip 100 are commonly used to avoid ESD stress applied to each of the chips 101 and 102, the ESD characteristic of the SIP chip 100 could be improved. Therefore, there has been a need for an ESD protecting circuit capable of avoiding the ESD stress in each chip 101 or 102 by commonly using power voltages in the SIP chip 100.

FIG. 2 is a circuit diagram illustrating an ESD (electrostatic discharge) protecting circuit in an SIP (system-in-package) chip according to an embodiment of the present invention. The SIP chip 200 includes an ESD protecting circuit 110 connected between the power voltage VDD1 and the first ground voltage VSS1 in the first chip 101 and another ESD protecting circuit 120 connected between the second power voltage VDD2 and the second ground voltage VSS2 in the second chip 102. Additionally, the SIP chip 200 further includes coupling diode units 210 and 220 between the first power voltage VDD1 and the second power voltage VDD2 as well as between the first ground voltage VSS1 and the second ground voltage VSS2, respectively. In the coupling diode units 210 and 220, a plurality of diodes are serially connected in a bidirectional manner.

The SIP chip 200 according to the present invention operates against ESD stress in accordance with the following. For convenience of description, in a first case, it is assumed that the first power voltage VDD1 is set to have a higher voltage level than the second power voltage VDD2, and the second ground voltage VSS2 is set to have a lower voltage level than the first ground voltage VSS1.

If a high positive voltage is applied to the first pad PAD1, a current path is formed from the first pad PAD1 to the first power voltage VDD1 through a first diode 111. Similarly, another current path is formed from the first power voltage VDD1 to the second power voltage VDD2 through a first coupling diode unit 210. Therefore, the high positive voltage in the first pad PAD1 is discharged to the first power voltage VDD1 and the second power voltage VDD2.

If a high negative voltage is applied to the first pad PAD1, a current path is formed from the first ground voltage VSS1 to the first pad PAD1 through a second diode 112. Similarly, another current path is formed from the second ground voltage VSS2 to the first ground voltage VSS1 through a second coupling diode unit 220. Therefore the high negative voltage in the first pad PAD1 is discharged to the first ground voltage VSS1 and the second ground voltage VSS2.

In a second case, it is assumed that the second power voltage VDD2 is set to have a higher voltage level than the first power voltage VDD1, and the first ground voltage VSS1 is set to have a lower voltage level than the second ground voltage VSS2.

If a high positive voltage is applied to the second pad PAD2, a current path is formed from the second pad PAD2 to the second power voltage VDD2 through a third diode 121. Similarly, another current path is formed from the second power voltage VDD2 to the first power voltage VDD1 through the first coupling diode unit 210. Therefore, the high positive voltage in the second pad PAD2 is discharged to the first power voltage VDD1 and the second power voltage VDD2.

If a high negative voltage is applied to the second pad PAD2, a current path is formed from the second ground voltage VSS2 to the second pad PAD2 through a fourth diode 122. Similarly, another current path is formed from the first ground voltage VSS1 to the second ground voltage VSS2 through the second coupling diode unit 220. Therefore, the high negative voltage in the second pad PAD2 is discharged to the first ground voltage VSS1 and the second ground voltage VSS2.

The high voltage ESD stress applied to the first or second chip 101 or 102 sinks through the current path formed by the coupling diode units 201 or 220 to the power source of the other chip 101 or 102 in the SIP chip 200 as well as its individual power source. For this reason, the ESD stresses applied to the first and second chips 101 and 102 can be minimized.

The coupling diode units 210 and 220 according to the present invention include a plurality of diodes to prevent the power noise generated in the first or the second chip 101 or 102 from being coupled to the second or first chip 102 or 101, respectively. The coupling diode units 210 and 220 can be embedded in the first or second chip 101 or 102. Also, they can be mounted on a package board or a PCB board during packaging.

In the embodiment of the present invention, two exemplary chips (i.e., the first and the second chips 101 and 102) embedded in the SIP chip 200 are described. Similarly, the preset invention can be extended to a plurality of chips embedded in the SIP chip 200 by connecting different power sources through the coupling diode units to minimize the ESD stress.

In addition, the concept of the present invention can be applied to one chip using a plurality of power sources by the coupling diode units connected among the power sources having different power levels.

The preferred embodiments of the present invention are disclosed in the drawings and the specification, as described above. In addition, although specific terms have been used hereto, the terms are intended to describe the present invention, but not intended to limit a meaning or restricting the scope of the present invention written in the following claims. Accordingly, it will be understood by those of ordinary skill in the art that various changes in form and details may be made therein without departing from the spirit and scope of the present invention as defined by the following claims.

1. A system-in-package chip comprising:
a first chip having a first electrostatic discharge protecting circuit between a first power voltage and a first ground voltage;
a second chip having a second electrostatic discharge protecting circuit between a second power voltage and a second ground voltage;
a first coupling diode unit having a plurality of diodes which are serially connected between the first power voltage and the second power voltage in a bidirectional manner; and
a second coupling diode unit having a plurality of diodes which are serially connected between the first ground voltage and the second ground voltage in a bidirectional manner.

2. The system-in-package chip according to claim 1, wherein the first electrostatic discharge protecting circuit includes:
a first diode connected from a predetermined pad in the first chip to the first power voltage; and
a second diode connected from the first ground voltage to the pad.

3. The system-in-package chip according to claim 1, wherein the second electrostatic discharge protecting circuit includes:
a first diode connected from a predetermined pad in the second chip to the second power voltage; and
a second diode connected from the second ground voltage to the pad.

4. An integrated circuit using a plurality of power sources comprising:
a first power voltage;
a second power voltage having a voltage level different than the first power voltage;
a first ground voltage;
an electrostatic discharge protecting circuit connected among the first power voltage, a predetermined pad in the integrated circuit, and the first ground voltage; and
a first coupling diode unit having a plurality of diodes which are serially connected between the first power voltage and the second power voltage in a bidirectional manner.

5. The integrated circuit according to claim 4, further comprising:
a second ground voltage having a voltage level difference than the first ground voltage; and
a second coupling diode unit having a plurality of diodes which are serially connected between the first ground voltage and the second ground voltage in a bidirectional manner.
